(19) United States
(12) Patent Application Publication
(10) Pub. No.: US 2018/0182046 A1
(43) Pub. Date: Jun. 28, 2018

(54) TRANSMITTING AN ELECTRICITY FLOW

(71) Applicant: Futurewei Technologies, Inc., Plano, TX (US)

(72) Inventors: Jiafeng ZHU, Plano, TX (US); Stephen Morgan, Plano, TX (US)

(73) Assignee: Futurewei Technologies, Inc., Plano, TX (US)

(21) Appl. No.: 15/393,009

(22) Filed: Dec. 28, 2016

(51) Int. Cl. G06Q 50/06; H04L 12/10

(52) U.S. Cl. CPC G06Q 50/06; H04L 12/10

(57) ABSTRACT

A user device may transmit a request for electricity via a wire to a smart device, where the request includes the universal unique identifier (UUID) of the user device. Upon the reception of the UUID, the smart device may enable an electricity flow to the user device. The smart device may further measure the electricity amount of the electricity flow enabled to the user device based on the UUID. Based on the UUID, the smart device may measure the electricity amount enabled to a specific user device. Consequently, the calculation of electricity cost may be implemented for a specific user device. In some embodiments, the smart device may calculate the electricity cost for different user devices independently. Therefore, the calculation of electricity cost may be more accurate and smart.

### BACKGROUND

An electricity meter, electric meter, electrical meter, or energy meter is a device that measures the amount of electric energy consumed by a residence or a business. Electric utilities use electric meters installed at customers' premises to measure electric energy delivered to their customers for billing purposes. They are typically calibrated in billing units, the most common one being the kilowatt hour (kWh). They are usually read once each billing period. When energy savings during certain periods are desired, some meters may measure the maximum use of power in some interval. “Time of day” metering allows electric rates to be changed during a day, and to record usage during peak high-cost periods and off-peak, lower-cost, periods.

### SUMMARY

In one embodiment, the disclosure includes a method. According to the method, a smart device receives a first request for electricity via a first wire, where the first request comprises a universal unique identifier (UUID) of a user device. The smart device enables an electricity flow to the user device via the first wire upon the reception of the first request. The smart device further measures the electricity amount of the electricity flow enabled to the user device based on the UUID. Based on the UUID, the smart device may measure the electricity amount enabled to a specific user device. Consequently, the calculation of electricity cost may be implemented for a specific user device. Therefore, the calculation of electricity cost may be more accurate and smart.

In one embodiment, the disclosure includes a smart device. The smart device includes a memory including computer-readable instructions; and a processor coupled with the memory. The processor is configured to read the instructions to: receive a first request for electricity via a first wire, where the first request comprises a universal unique identifier (UUID) of a user device; enable an electricity flow to the user device via the first wire; and measure electricity amount of the electricity flow enabled to the user device based on the UUID. Based on the UUID, the smart device may measure the electricity amount enabled to a specific user device. Consequently, the calculation of electricity cost may be implemented by the smart device for a specific user device. Therefore, the smart meter may implement more accurate and smart calculation of electricity cost.

In one embodiment, the disclosure includes a system. The system a smart device; and a controller coupled to the smart device. The smart device is configured to: receive a first request for electricity via a first wire, where the first request comprises a universal unique identifier (UUID) of a user device; transmit a second request for electricity via a second wire to the controller, where the second request includes the UUID; receive a fee rate associated with the UUID from the controller via the second wire; enable an electricity flow to the user device via the first wire; and measure electricity amount of the electricity flow enabled to the user device based on the UUID. The controller is configured to: receive the second request from the smart device via the second wire; and transmit the fee rate associated with the UUID. Based on the UUID, the system may measure the electricity amount enabled to a specific user device. Consequently, the calculation of electricity cost may be implemented by the system for a specific user device. Therefore, the system may implement more accurate and smart calculation of electricity cost.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1 illustrates a schematic diagram of a system according to an embodiment of the disclosure.

FIG. 2 illustrates a schematic diagram of a meter according to an embodiment of the disclosure.

FIG. 3 illustrates a flow chart of a method for enabling an electricity flow to a user device according to an embodiment of the disclosure.

FIG. 4 illustrates a message exchange diagraph for enabling an electricity flow to a user device according to an embodiment of the disclosure.

FIG. 5 illustrates a flow chart of a method for enabling an electricity flow to a user device according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In some embodiments, a user device may transmit a request for electricity via a wire to a smart device, such as a smart meter, where the request includes the universal unique identifier (UUID) of the user device. Upon the reception of the UUID, the smart device may enable an electricity flow to the user device. The smart device may further measure the electricity amount of the electricity flow enabled to the user device based on the UUID. The electricity flow may be also known as an electric current. The electricity amount of the electricity flow enabled to the user device may be also known as the amount of electric energy of the electricity flow enabled to the user device or the amount of electric energy enabled to the user device. Based on the UUID, the smart device may measure the electricity amount enabled to a specific user device, where the measured electricity amount is associated with the UUID. Consequently, based on the measured electricity amount, the calculation of electricity cost may be implemented for the specific user device having the UUID among a plurality of user devices coupled with the meter. Therefore, the calculation of electricity cost may be more accurate and smart. Furthermore, based on the UUID, the smart device may control the electricity quality of the electricity flow enabled to the specific user device. In some embodiments, the smart device may respectively enable electricity flows with different qualities to different user devices coupled with the smart device.

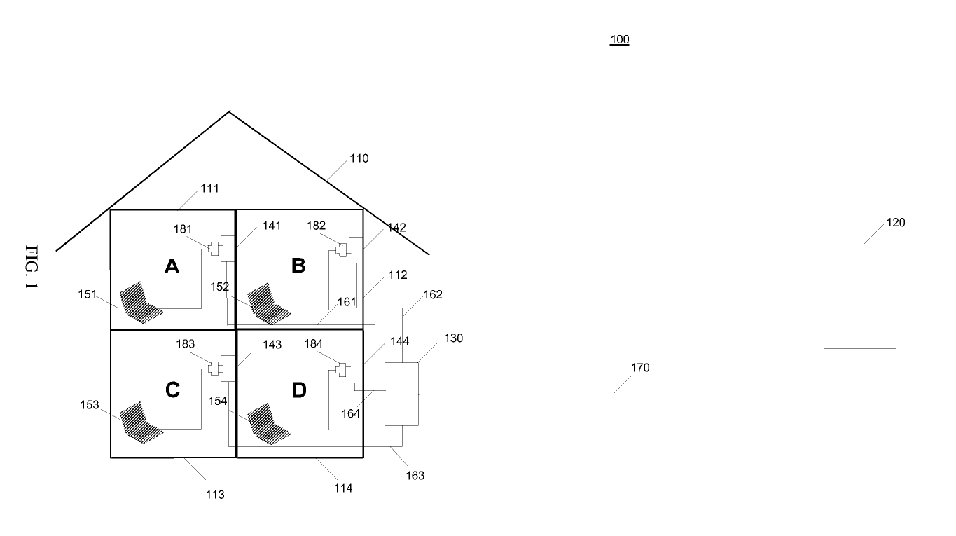

FIG. 1 illustrates a schematic diagram of a system 100 according to an embodiment of the disclosure. System 100 includes a controller 120 and a meter 130 that is coupled with the controller 120 via wire 170. Meter 130 is equipped at or close to building 110. Building 110 has a plurality of rooms, such as room A 111, room B 112, room C 113 and room D 114. In one embodiment, controller 120 is a server managed by an electrical power provider, such as PG&E and provides electricity flows to user devices registered at the power provider. The electricity flow may be also known as an electric current. Meter 130 may be used to measure the amount of electric energy enabled to user devices.

In one embodiment, there is an outlet in each room of building 110. As shown in FIG. 1, outlets 141-144 are located in rooms A 111, room B 112, room C 113, and room D 114 respectively. User devices 151-154 are coupled with outlets 141-144, respectively, via plugs 181-184. Outlets 141-144 are coupled with meter 130 via wires 161-164, respectively, so that meter 130 may measure the electricity amount of electricity flows enabled to each of the user devices 151-154. In one embodiment, wires 161-164 and 170 are made of conductive medium, such as copper wires. Each of wires 161-164 and wire 170 may be used to enable the transmission of both energy (electricity flows) and data, e.g. control data, based on power-line communication. In some embodiments, in order to enable the transmission of energy, controller 120 may, directly or indirectly, transmit electricity flows from a power supply to meter 130 via wire 170. Meter 130 may enable the electricity flows to user devices. For example, meter 130 may enable the electricity flows to user device 151-154 via wires 161-164 and outlets 141-144. In some embodiments, the enabling an electricity flow to a user device by meter 130 may represent that meter 130 transmits the electricity flow to the user device, or meter 130 transmits an instruction to a transmitting device so that the transmitting device transmits the electricity flows to the user devices. Furthermore, meter 130 may exchange data, such as control data, with user devices plugged in outlets 141-144 via wires 161-164, and exchange data with controller 120 via wire 170. Therefore, the data and the electricity flows may share the same wires. The data may include the request for electricity, the electricity quality level associated with the electricity flow, and fee rate associated with the electricity flow.

In some embodiments, each of user devices 151-154 may be equipped with a universal unique identifier (UUID). The UUID, which is a 16-octet (128-bit) number, is an identifier standard used in software construction. For human-readable display, many systems use a canonical format using hexadecimal text with inserted hyphen characters. For example, a UUID may be displayed as:
123e4567-e89b-12d3-a456-426655440000

A UUID enables a controller in a distributed system to uniquely identify information associated with the device having the UUID without significant central coordination. In this context the word unique should be taken to mean “practically unique” rather than “guaranteed unique.” The UUID may be equipped in the body of a user device or in a plug of a user device.

When a plug, such as plug 181 of user device 151, is plugged in an output 141, the UUID of user device 151 may be transmitted to meter 130 via wire 161.

In some embodiments, before a plug of a user device having a UUID is plugged in an output, the UUID may already be registered at controller 120. Based on the UUID registration, controller 120 may have a fee mapping between the UUID and the fee rate and a quality mapping between the UUID and the electricity quality level. In some embodiments, controller 120 may transmit these mappings to meter 130 before the user device is coupled with the outlet via its plug.

In some embodiments, meter 130 may determine an electricity flow for a user device having the UUID based on the electricity quality level associated with the UUID, e.g. the electricity quality level in the quality mapping, and enable the determined electricity flow to the user device, such as user device 151. Furthermore, meter 130 may calculate electricity cost for the user device based on the fee rate associated with the UUID, e.g. the fee rate in the fee mapping, and the electricity amount of the electricity flow to user device 151.

Based on the UUID of a user device, such as the UUID of user device 151, meter 130 may calculate electricity cost for the user device based on the UUID, rather than calculating the electricity cost for all devices in a whole building, such as building 110. Furthermore, based on the UUID of a user device, meter 130 may select an electricity flow for the user device based on the electricity quality level in the quality mapping. The electricity quality level may be registered to the controller when the user of the user device registers the UUID of to the power company. In some embodiments, the fee rate associated with the UUID and the electricity quality level associated with the UUID may be got by a meter equipped at a subsequent building. Consequently, when the user device moves to the subsequent building, the meter equipped at the subsequent building may enable an electricity flow to the user based on the electricity quality level and calculate the electricity cost for the user device based on the fee rate.

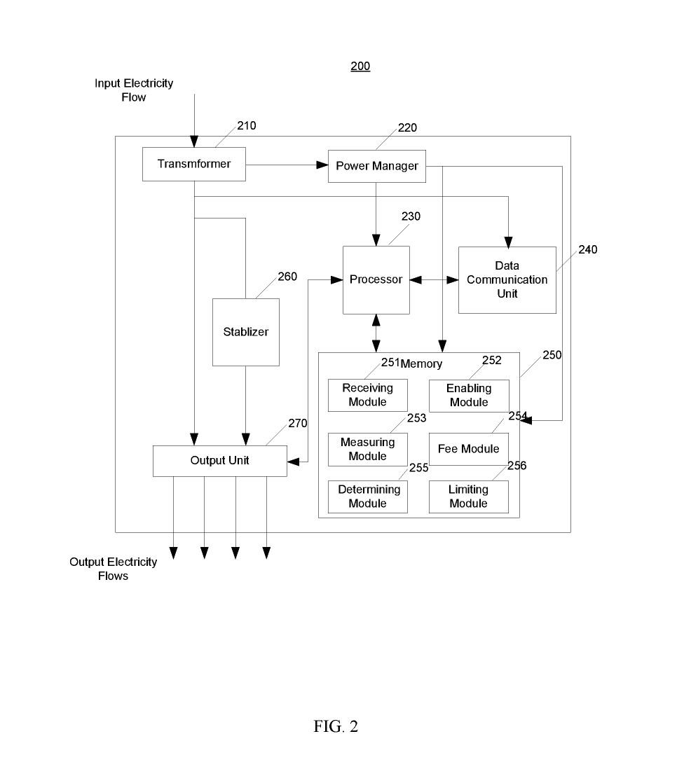

FIG. 2 illustrates a schematic diagram of a meter 200 according to an embodiment of the disclosure.

As illustrated in FIG. 2, smart device 200 may include a transformer 210, power manager 220, processor 230, data communication unit 240, memory 250, stabilizer 260, and output unit 270. In some embodiments, smart device 200 may be meter 130 in FIG. 1. Transformer 210 may be configured to transform the voltage of an input electricity flow, received from a power provider, from a high voltage level to a low voltage level, such as from 220 v to 110 v. The electricity flow may also be known as an electric current. Power manager 220 may be configured to provide power supply to elements inside device 200, such as processor 230, data communication unit 240, memory 250, etc. Processor 230 may represent one or more processors. Processor 230 may be implemented as a general processor or may be part of one or more application specific integrated circuits (ASICs) and/or digital signal processors (DSPs). Data communication unit 240 is configured to transmit and receive data based on power line communication. Data communication unit 240 may transmit the data received from the user devices and/or the controller of the power provider, such as controller 120 in FIG. 1 to processor 230 for further process. Data communication unit 240 may further receive data from processor 230 and transmit the data received from processor 230 to the user devices and/or the controller, such as controller 120 in FIG. 1. Stabilizer 260 is configured to stabilize the electricity flow output by transformer 210 to generate a more stable electricity flow. Output unit 270 is configured to receive instructions from processor 230 to determine an electricity flow output to a user device. When the instruction from processor 230 indicates outputting an electricity flow with higher quality, output unit 270 may output the electricity flow stabilized by stabilizer 260. When the instruction indicates outputting an electricity flow with lower quality, the output unit 270 may output the electricity flow that is not stabilized by stabilizer 260 to the user device. In some embodiments, because smart device 200 may respectively enable electricity flows having different electricity quality levels to different user devices, output unit 270 may output a plurality of electricity flows. Memory 250 is coupled with processor 230. In some embodiments, memory 250 may be a random access memory (RAM), such as a dynamic RAM (DRAM) or a static RAM (SRAM), or a read only memory (ROM). In some embodiments, memory 250 may be a solid-state drive (SSD) or a hard disk drive (HDD). In some embodiments, memory 250 may both include RAM or ROM and include an SSD or HDD.

Memory 250 may include a plurality of software modules each including computer readable instructions. In some embodiments, the plurality of software modules are configured to perform a plurality of operations. When a software module is configured to perform an operation, it may mean that processor 230 reads instructions in the software module to perform the operation. The operation may be directly or indirectly performed by processor 230. In some embodiments, receiving module 251 is configured to receive a request for electricity via a wire, where the request comprises a universal unique identifier (UUID) of a user device. In some embodiments, enabling module 252 is configured to enable an electricity flow to the user device via the wire. In some embodiments, measuring module 253 is configured to measure the electricity amount of the electricity flow enabled to the user device based on the UUID. The electricity amount may also be known as the amount of electric energy.

In some embodiments, enabling module 252 is further configured to transmit a subsequent request for electricity to a controller of the power provider, such as controller 120 in FIG. 1. In some embodiments, the subsequent request is transmitted to the controller as a response to the request received from the user device. In response to the subsequent request, if the UUID is registered at the controller of the power provider, such as controller 120 in FIG. 1, the controller of the power provider may transmit a response to the smart device. In some embodiments, the response transmitted to the smart device may include the fee mapping between the fee rate and the UUID. In some embodiments, the response transmitted to the smart device may include the quality mapping between the electricity quality level and the UUID.

In some embodiments, receiving module 251 is further configured to receive the fee mapping between the fee rate and the UUID from the controller via a subsequent wire, where the fee mapping is used to determine the fee rate. Fee module 254 is configured to determine the fee rate for the user device based on the UUID and the fee mapping. Furthermore, fee module 254 may calculate electricity cost for the user device based on the electricity amount of the electricity flow enabled to the user device and the determined fee rate.

In some embodiments, receiving module 251 is further configured to receive the quality mapping between the electricity quality level and the UUID from the controller. Determining module 255 is configured to determine an electricity quality level based on the UUID and the quality mapping. Determining module 255 is further configured to determine the electricity flow based on the electricity quality level. In some embodiments, when the electricity quality level is higher than a threshold, the determined electricity flow may be an electricity flow stabilized by stabilizer 260 in the smart device. In some embodiments, when the electricity quality level is lower than the threshold, the determined electricity flow may be an electricity flow without stabilization by stabilizer 260 in the smart device.

In some embodiments, receiving module 251 is further configured to receive an instruction from the controller, such as controller 120 in FIG. 1, where the instruction informs the smart device of limiting the electricity flow enabled to the user device. Limiting module 256 is configured to limit the electricity flow enabled to the user device. In some embodiments, in order to limit the electricity flow, limiting module 256 is configured to stop enabling the electricity flow to the user device.

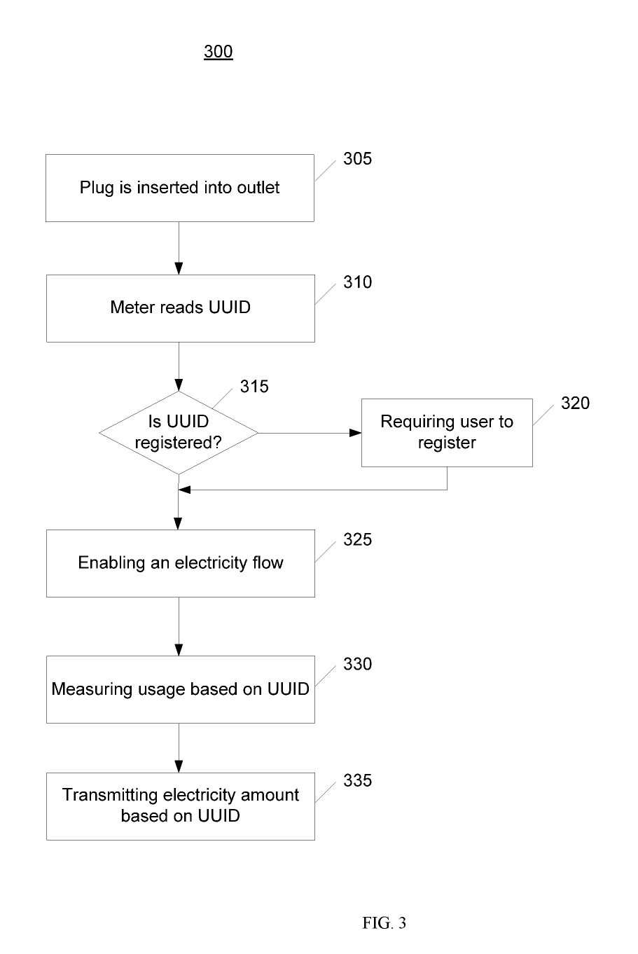

FIG. 3 illustrates a flow chart of a method 300 for enabling an electricity flow to a user device according to an embodiment of the disclosure.

At operation 305, the plug, e.g. plug 181 in FIG. 1, of a user device, e.g. user device 151, is inserted into an outlet, e.g. outlet 141. The user device may be a computer, a refrigerator, a TV, a washing machine etc. The user device is equipped with a Universal Unique Identifier (UUID). In some embodiments, the UUID may be equipped in the body of the user device, such as in the power circuit of the user device. In some embodiments, the UUID may be equipped in the plug of the user device.

At operation 310, the meter, e.g., smart meter 130, reads the UUID of the user device. After the plug is inserted into the outlet, the UUID may be transmitted to the meter so that the meter may read the UUID. The UUID may be transmitted to the meter from the user device to the meter via the electrical wire between the user device and the meter, e.g. wire 161 in FIG. 1. In some embodiments, when UUID is equipped in the body of the user device, transmitting the UUID from the user device to the meter refers to transmitting the UUID from body of the user device to the meter via the plug. In some embodiments, when UUID is equipped in the plug, transmitting the UUID from the plug to the meter refers to transmitting the UUID from the plug to the meter.

At operation 315, the meter determines whether the UUID is registered for using electricity. If the UUID isn't registered, method 300 proceeds to operation 320. When the UUID is registered, method 300 proceeds to operation 325.

At operation 320, the meter may transmit a notification to the user device, where the notification is used for informing the user device of registering the UUID for using electricity. Registering the UUID of the user device may mean registering the user device.

At operation 325, the meter enables an electricity flow to the user device.

In some embodiments, the electricity flow may be also known as an electric current. In some embodiments, the electricity flow enabled to the user device is determined based on the electricity quality level associated with the user device. The electricity quality level associated with the user device may be received from a controller of power provider. Furthermore, the electricity quality level associated with the user device is the electricity quality level associated with the UUID of the user device.

In an example, the meter may store a table in a memory, such as Table 1 as follows:

TABLE 1

| UUID | Electricity Quality Level |
|---|---|
| UUID_1 | L_a |
| UUID_2 | L_a |
| UUID_3 | L_b |
| UUID_4 | L_c |

As shown in Table 1, both UUID_1 and UUID_2 correspond to quality level L_a, UUID_3 corresponds to quality level L b, and UUID_4 corresponds to quality level L_c. When the UUID of the user device is UUID_1 or UUID_2, the electricity quality level of the electricity flow enabled to the user device may be L_a; when the UUID of the user device is UUID_3, the electricity quality level of the electricity flow enabled to the user device may be L b; when the UUID of the user device is UUID_4, the electricity quality level of the electricity flow enabled to the user device may be L_c.

Based on the correspondence between the UUIDs of the user devices and the electricity quality levels, different user devices coupled with the same meter may get electricity flows associated with different electricity quality levels. In some embodiments, based on the users' registration, the correspondence between the UUIDs of the user devices and the quality levels is established at the controller, such as controller 120. During the registration, a UUID of a user device may be registered to the controller by the user device via wireless or cabled internet or be manually registered by the user at the office of the power provider.

At operation 330, the meter measures the electricity amount of the electricity flow enabled to the user device. Based on this method, the meter may determine the electricity amount of electricity flow used by a specific user device, rather than the electricity amount of electricity flows used by the entire home or building. In some embodiments, the electricity amount may be also known as electric energy.

At operation 335, the meter transmits the electricity amount of the electricity flow enabled to the user device to the controller, such as controller 120 in FIG. 1. In some embodiments, the controller may calculate the electricity cost for the user device so that the user of the user device may get a piece of billing information for his user device. In some embodiments, in order to transmit the electricity amount of the electricity flow enabled to the user device, the meter transmits the mapping between the electricity amount and the UUID of the user device in one message.

In some embodiments, the meter may use the UUID of the user device and the fee mapping between the UUID and the fee rate to determine the fee rate for the user device. After determining the fee rate, the meter may calculate the electricity cost for the user device based on the electricity amount of the electricity flow and the fee rate.

In an example, the meter may store a table in a memory, such as Table 2 as follows:

TABLE 2

| UUID | Fee Rate |
|---|---|
| UUID_1 | R_a |
| UUID_2 | R_a |
| UUID_3 | R_b |
| UUID_4 | R_c |

According to Table 2, when the UUID of the user device is UUID_1 or UUID_2, the corresponding fee rate is R_a; when the UUID of the user device is UUID_3, the corresponding fee rate is R_b; and when the UUID of the user device is UUID_4, the corresponding fee rate is R_c.

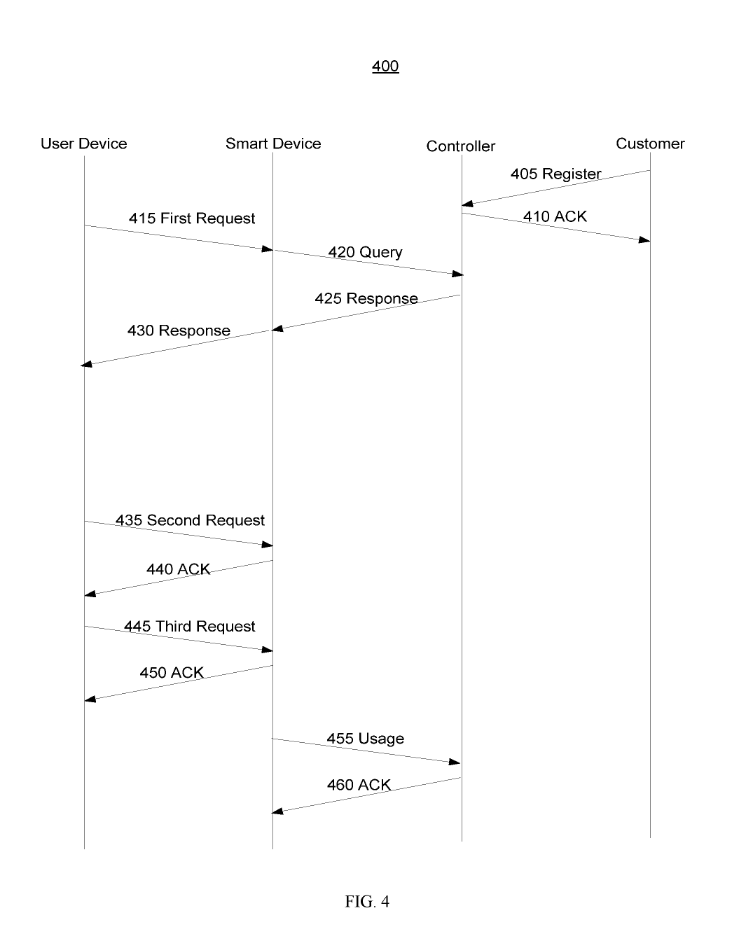

FIG. 4 illustrates a message exchange diagraph for enabling an electricity flow to a user device according to an embodiment of the disclosure.

At operation 405, a consumer (user) registers the UUID of a user device to a controller via a registration machine. The controller may be a server of a power company, such as PG&E. The registration machine may be a personal computer or may be a machine specially designed for registration.

At operation 410, the controller transmits an acknowledgement (ACK) message to the registration machine. The ACK may indicate the registration is successful.

At operation 415, the user device transmits a request for electricity (first request) to the meter. The first request may be used for requesting an electricity flow for the user device. The first request may include the UUID of the user device. The UUID may be equipped in the body of user device or in the plug of the user device. In some embodiments, the electricity flow may be also known as the electric current.

At operation 420, the meter transmits a message to the controller to determine whether an electricity flow may be enabled to the user device having the UUID. In some embodiments, the message may further be used to request the electricity quality level of the electricity flow to be enabled to the user device.

At operation 425, upon the reception of first request, the controller transmits a response message to the meter. Because the UUID has been registered at the server at operation 405, the controller determines that the user device is qualified to receive an electricity flow. Therefore, the response from the server to the meter is used for informing the meter that the meter may enable an electricity flow to the user device. In some embodiments, the response includes the electricity quality level of the electricity flow to be enabled to the user device.

At operation 430, after receiving the response, the meter may transmit a subsequent response to the user device. The subsequent response may be used to inform the user device that the user device is qualified to receive an electricity flow. In some embodiments, the subsequent response further includes the electricity quality level of the electricity flow that the user device is qualified to receive. Furthermore, the meter may further enable an electricity flow that the user device is qualified to receive to the user device.

At operation 435, the user device may transmit a request for electricity (second request) to the meter.

After the user device uses the electricity flow associated with the first request at operation 415 for a time period, the use device may stop using the electricity flow. For example, the consumer may turn off the power button of the user device or take the plug of the user device out of the output. After another time period during which no electricity flow is transmitted to the user device, the user device may need to use an electricity flow again. Therefore, at operation 435, the user device transmits the second request for receiving an electricity flow.

At operation 440, the meter may transmit an ACK message to the user device. Because the meter knows, based on the response received at operation 425, that the user device is qualified for receiving an electricity flow, the ACK message at operation 440 may be used to inform the user device that the user device is qualified for receiving an electricity flow. In some embodiments, the ACK message may further indicate the electricity quality level of the electricity flow that the user device is qualified to receive. In some embodiments, the meter further enables an electricity flow to the user device that the user device is qualified to receive.

At operation 445, the user device may transmit a request for electricity (third request) to the meter.

After the user device uses the electricity flow associated with the second request at operation 435 for a time period, the user device may stop the usage of the electricity flow. After another time period during which no electricity flow is transmitted to the user device, the user device may need to use electricity flow again. Therefore, at operation 445, the user device transmits the third request for receiving an electricity flow.

At operation 450, the meter may transmit an ACK message to the user device. Because the meter knows, based on the response received at operation 425, that the user device is qualified for receiving an electricity flow, the ACK message at operation 450 may be used to inform the user device that the user device is qualified for receiving an electricity flow. In some embodiments, the ACK message may further indicate the electricity quality level of the electricity flow that the user device is qualified to receive. In some embodiments, the meter further enables an electricity flow that the user device is qualified to receive to the user device.

At operation 455, the meter may transmit usage static to the controller. The usage static may include the amount of electric energy enabled to the user device in a time period. The usage static may further include the electricity quality level of the electric energy enabled to the user device. In some embodiments, in a section of the time period, the electricity amount of electric energy enabled to the user device may be amount A and the electricity quality level of the electric energy may be level A. In a subsequent section of the time period, the electricity amount of electric energy enabled to the user device or another user device may be amount B and the electricity quality level of the electric energy may be level B. The usage static may consequently include the mapping of amount A, level A and UUID of the user device. The usage static may further include the mapping of amount B, level B and the UUID of the user device when the amount B is the amount of electric energy enabled to the user device, or the mapping of amount B, level B and the UUID the another user device when the amount B is the amount of electric energy enabled to the another user device.

At operation 460, the controller may transmit an ACK to indicate that the usage static is received by the controller.

In some embodiments, when the controller of the power company detects that the UUID is registered at the controller, the controller may inform a different controller of a different power provider of the registration of the UUID. Therefore, when user device is plugged in an output coupled with the different power company, the user may be billed by the different power company independently. Furthermore, the controller of the different power company may know the electricity quality level associated with the UUID. Consequently, the controller of the different power company may enable an electricity flow associated with the electricity quality level to be transmitted to the user via a meter. In some embodiments, when an electricity flow is associated with electricity quality level L_A, the electricity quality level of the electricity flow is L_A.

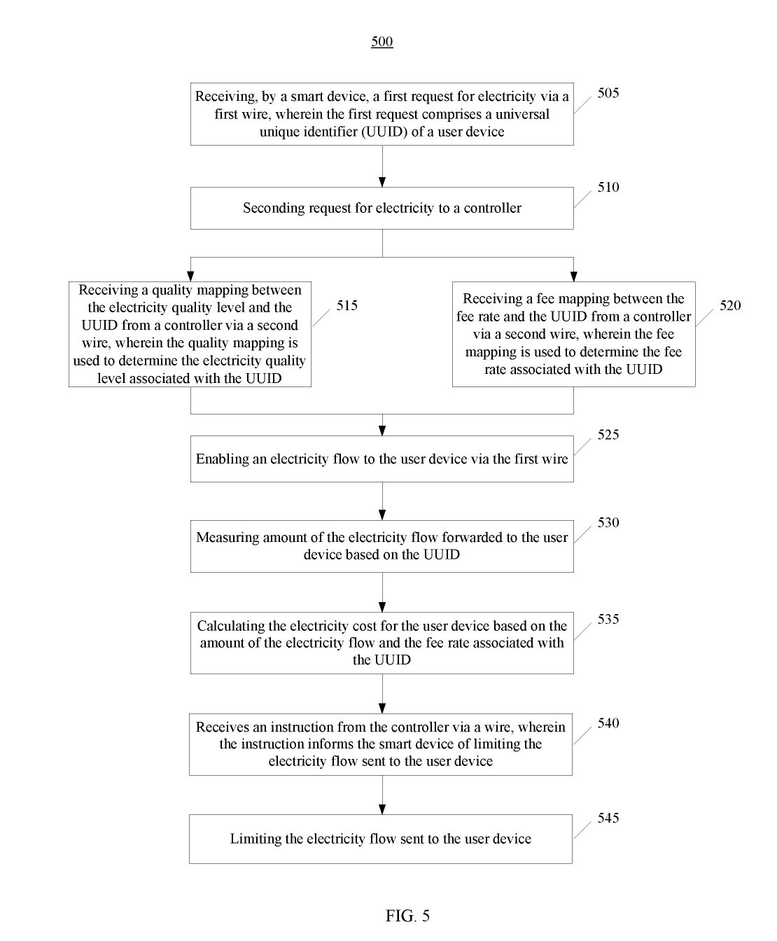

FIG. 5 illustrates a flow chart of a method 500 for enabling an electricity flow to a user device according to an embodiment of the disclosure.

At operation 505, a smart device, such as a meter, receives a request for electricity via a wire, where the request comprises a universal unique identifier (UUID) of a user device.

The wire is made of conductive medium, such as copper. The wire, which may be a power cable, is both used to receive the data, such as the request, and also may be used for electricity transmission. The request may be transmitted by the user device to the smart device based on power line communication. Power-line communication is a communication technology that enables transmitting both data and current over existing power cables. The power-line communication may be implemented either based on alternating current (AC) line or direct current (DC) line. Power-line communication is also known as power-line carrier, power-line digital subscriber line (PDSL), mains communication, power-line telecommunications, or power-line networking (PLN). The UUID may be equipped in the body of the user device, such as a laptop or refrigerator, or in the plug of the user device. In some embodiments, the request is transmitted either by the body of the user device or by the plug of the user device, once the plug in plugged in an outlet coupled with the smart device via the wire.

At operation 510, the smart device transmits a subsequent request for electricity to a controller.

In some embodiments, the subsequent request is the same as the request. In some embodiments, the subsequent request is different the request, but the subsequent request includes the UUID. In some embodiments, the subsequent request may be transmitted to the controller of the power provider before the reception of the request by the smart device. In some embodiment, operation 510 is optional, because the smart device may enable an electricity flow to the user device based on a default configuration.

At operation 515, the smart device receives a quality mapping between a electricity quality level and the UUID from the controller of the power provider via a subsequent wire, where the quality mapping is used to determine the electricity quality level for the user device. In some embodiments, operation 515 is optional at least because the smart device may be configured with a default quality level and the smart device only enable electricity flows associated with the default quality level to the user device.

At operation 520, the smart device receives a fee mapping between a fee rate and the UUID from a controller via a subsequent wire, where the fee mapping is used to determine the fee rate for the user device. In some embodiments, operation 520 is optional at least because the smart device may transmit the measured electricity amount to the controller, so that the controller, rather than the meter, may calculate the electricity cost for the user device. In some embodiments, the electricity amount may be also known as the amount of electric energy.

At operation 525, the smart device enables an electricity flow to the user device via the wire.

In response to the reception of the request for electricity, the smart device enables the electricity flow to the user device via the wire.

In some embodiments, the smart device may determine an electricity quality level based on the UUID. For example, when the smart device receives the quality mapping between the electricity quality level and the UUID at operation 515, the smart device may determine the electricity quality level based on the UUID received at operation 505 and the quality mapping received at operation 515.

Based on the determined electricity quality level, the smart device may determine the electricity flow to be enabled to the user device. For example, when the electricity quality level is higher than a threshold, the electricity quality level may determine an electricity flow stabilized by a stabilizer in the user device as the electricity flow to be enabled to the user device. When the electricity quality level is lower than a threshold, the electricity quality level may determine an electricity flow without stabilization as the electricity flow to be enabled to the user device.

In some embodiments, in order to enable the determined electricity flow to the user device, the smart device transmits the determined electricity flow by itself. In some embodiments, in order to enable the determined electricity flow to the user device, the smart device informs a transmitting device of transmitting the determined electricity flow.

At operation 530, the smart device measures the electricity amount of the electricity flow enabled to the user device based on the UUID.

At operation 535, the smart device calculates the electricity cost for the user device based on the electricity amount of the electricity flow and the fee rate associated with the UUID. The fee rate associated with the UUID actually is the fee rate associated with or for the electricity flow enabled to user device having the UUID, or is the fee rate associated with or for the user device having the UUID.

In some embodiments, the smart device may calculate the electricity cost for the user device based on a default fee rate associated with any electricity flow enabled by the smart device.

In some embodiments, when the smart device receives the fee mapping between the fee rate and the UUID at operation 520, the smart device may determine the fee rate associated with or for the electricity flow enabled to the user device based on the fee mapping received at operation 520 and the UUID received at operation 505.

In some embodiments, operation 535 is optional because the smart device may not calculate the electricity cost by itself. Instead, the smart device may transmit the electricity amount of the electricity flow to the controller to calculate the electricity cost.

At operation 540, the smart device receives an instruction from the controller via a wire, where the instruction informs the smart device of limiting the electricity flow enabled to the user device.

In some embodiments, the instruction may include the UUID of the user device. The smart device may limit the electricity flow associated with the UUID. In some embodiments, the electricity flow associated with the UUID may be an electricity flow that identified by the UUID.

In some embodiments, the instruction may include an electricity quality level. The smart device may determine whether the electricity quality level associated with the electricity flow enabled to the user device is the same as the quality level included in the instruction. If same, the smart device limits the electricity flow enabled to the user device.

At operation 545, the smart device limits the electricity flow enabled to the user device.

In some embodiments, limiting the electricity flow enabled to the user device may refer to stopping enabling the electricity flow to the user device.

In addition, techniques, systems, subsystems, and methods described and illustrated in the various embodiments as discrete or separate may be combined or integrated with other systems, modules, techniques, or methods without departing from the scope of the presented disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method, comprising:
receiving, by a smart device, a first request for electricity via a first wire, wherein the first request comprises a universal unique identifier (UUID) of a user device;
enabling, by the smart device, an electricity flow to the user device via the first wire; and
measuring, by the smart device, electricity amount of the electricity flow enabled to the user device based on the UUID.

2. The method of claim 1, comprising:
determining, by the smart device, a fee rate for the user device based on the UUID; and
calculating, by the smart device, electricity cost for the user device based on the electricity amount of electricity flow and the fee rate.

3. The method of claim 1, the enabling, by the smart device, an electricity flow to the user device via the first wire comprising:
determining, by the smart device, an electricity quality level based on the UUID;
determining, by the smart device, the electricity flow based on the electricity quality level; and
enabling, by the smart device, the determined electricity flow to the user device.

4. The method of claim 3, wherein the determining, by the smart device, the electricity flow based on the electricity quality level comprises:
selecting an electricity flow stabilized by an stabilizer in the smart device as the determined electricity flow based on the electricity quality level.

5. The method of claim 1, further comprising:
receiving, by the smart device, an instruction from a controller via a second wire, wherein the instruction informs the smart device of limiting the electricity flow enabled to the user device; and
limiting, by the smart device, the electricity flow enabled to the user device.

6. The method of claim 5, wherein limiting the electricity flow comprises:
stopping, by the smart device, enabling the electricity flow to the user device.

7. The method of claim 3, further comprising:
receiving, by the smart device, a quality mapping between the electricity quality level and the UUID from a controller via a second wire, wherein the quality mapping is used to determine the electricity quality level.

8. The method of claim 2, further comprising:
receiving, by the smart device, a fee mapping between the charging rate and the UUID from a controller via a second wire, wherein the fee mapping is used to determine the fee rate.

9. The method of claim 1, further comprising:
transmitting, by the smart device, a second request for electricity to a controller upon reception of the first request, wherein the second request comprises the UUID.

10. A smart device, comprising:
a memory including computer-readable instructions; and
a processor coupled with the memory, wherein the processor is configured to read the instructions to:
receive a first request for electricity via a first wire, wherein the first request comprises a universal unique identifier (UUID) of a user device;
enable an electricity flow to the user device via the first wire; and
measure electricity amount of the electricity flow enabled to the user device based on the UUID.

11. The smart device of 10, wherein the processor is further configured to read the instructions to:
determine a fee rate for the user device based on the UUID; and
calculate electricity cost for the user device based on the electricity amount of the electricity flow and the fee rate.

12. The smart device of claim 10, wherein the processor is further configured to read the instructions to:
determine an electricity quality level based on the UUID;
determine the electricity flow based on the electricity quality level; and
enable the determined electricity flow to the user device.

13. The smart device of claim 12, wherein the processor is further configured to read the instructions to:
enable an electricity flow received from a controller to an input port of a voltage stabilizer in the smart device to generate the electricity flow when the electricity quality level is higher than a threshold value.

14. The smart device of claim 10, wherein the processor is further configured to read the instructions to:
receive an instruction from a controller via a second wire, wherein the instruction informs the smart device of limiting the electricity flow enabled to the user device; and
limit the electricity flow enabled to the user device.

15. The smart device of claim 14, wherein the processor is further configured to read the instructions to:
limit the electricity flow by stopping enabling the electricity flow to the user device.

16. The smart device of claim 12, wherein the processor is further configured to read the instructions to:
receive a quality mapping between the electricity quality level and the UUID from a controller via a second wire, wherein the quality mapping is used to determine the electricity quality level.

17. The smart device of claim 11, wherein the processor is further configured to read the instructions to:
receive a fee mapping between the charging rate and the UUID from a controller via a second wire, wherein the fee mapping is used to determine the fee rate.

18. The smart device of claim 10, the processor is further configured to read the instructions to:
transmit a second request for electricity to a controller upon reception of the first request, wherein the second request comprises the UUID.

19. A system, comprising:
a smart device; and
a controller coupled to the smart device,
wherein the smart device is configured to:
receive a first request for electricity via a first wire, wherein the first request comprises a universal unique identifier (UUID) of a user device;
transmit a second request for electricity via a second wire to the controller, wherein the second request includes the UUID;
receive a fee rate associated with the UUID from the controller via the second wire;
enable an electricity flow to the user device via the first wire; and
measure electricity amount of the electricity flow enabled to the user device based on the UUID, and
wherein the controller is configured to:
receive the second request from the smart device via the second via; and
transmit the fee rate associated with the UUID.

20. The system of claim 19, wherein the controller is further configured to
transmit an electricity quality level associated with the UUID to the smart device, and wherein
the smart device is further configured to
generate the electricity flow based on the electricity quality level.
